(19) United States
(12) Patent Application Publication
(10) Pub. No.: US 2026/0279917 A1
(43) Pub. Date: Sep. 17, 2026

(54) Laser Patterned Solid-State Batteries, And Methods of Making and Using the Same

(71) Applicant: Ensurge Micropower ASA, Oslo (NO)

(72) Inventors: Hui YANG, San Jose, CA (US); Alex YAN, San Jose, CA (US); Richard VAN DER LINDE, San Jose, CA (US); Arvind KAMATH, Los Altos, CA (US)

(21) Appl. No.: 19/561,806

(22) Filed: Mar. 10, 2026

Related U.S. Application Data
(60) Provisional application No. 63/770,413, filed on Mar. 12, 2025.

(51) Int. Cl. H01M 10/0585; H01M 4/04; H01M 4/131; H01M 4/136; H01M 4/66; H01M 10/0525; H01M 10/0562

(52) U.S. Cl. CPC H01M 10/0585; H01M 4/0404; H01M 4/0414; H01M 4/0426; H01M 4/0428; H01M 4/0471; H01M 4/131; H01M 4/136; H01M 4/662; H01M 4/663; H01M 10/0525; H01M 10/0562

(57) ABSTRACT

A method of making solid-state battery cells using laser patterning, and a solid-state battery cell made by the method are disclosed. The method includes forming a patterned insulator on a cathode layer on a substrate, blanket-depositing a solid-state electrolyte layer on the cathode layer and the patterned insulator, blanket-depositing an anode current collector (ACC) layer on the solid-state electrolyte layer, laser-patterning the ACC layer over the patterned insulator to form a plurality of anode current collectors (ACCs), and cutting or dicing the solid-state electrolyte layer, the patterned insulator and the cathode layer to form the battery cells. The patterned insulator defines a border or boundary between adjacent cells, and each ACC is in a corresponding cell. The cell includes these structures, plus an encapsulant on the ACC and an ACC sidewall of the cell, and a redistribution layer on the encapsulant and along the ACC sidewall, electrically contacting the ACC.

### CROSS-REFERENCE TO RELATED APPLICATIONS

This application claims the benefit of U.S. Provisional Patent Appl. No. 63/770,413, filed 2025, Mar. 12, pending, incorporated herein by reference in its entirety.

### TECHNICAL FIELD

The present disclosure generally relates to the field of solid-state and/or thin-film batteries. More specifically, embodiments of the present disclosure pertain to laser-patterned solid-state batteries (i.e., containing one or more laser-patterned layers), and methods of making and using the same.

### DISCUSSION OF THE BACKGROUND

Solid-state lithium batteries are ionic-charge storage devices that are ideally suited for wearable, IoT, and other applications due to their small size, safety, and high cyclability. In an “anode-less” architecture, a solid-state lithium battery is a multi-layer structure consisting of a cathode current collector (CCC), a cathode, a solid-state electrolyte, and an anode current collector (ACC). While the ACC is electrically separated from the CCC by the solid-state electrolyte, it usually has a smaller area or pattern than the CCC to avoid ACC-to-CCC shorting when cells are cut from a larger substrate (e.g., a roll or sheet).

One way to form the ACC is to blanket-deposit a film, then pattern it using photolithography and plasma-assisted etching. Besides the multiple steps required to achieve the patterning result, dry etching (e.g., using a plasma) of the ACC layer in solid-state lithium batteries can cause lithium-ion (Li⁺) movement before charging or discharging the battery, which induces low coulombic efficiency (CE), lower battery storage capacity, shorter cycling times, and possibly a shorter lifetime.

For example, FIG. 1 shows an intermediate structure 100 for a solid-state lithium battery cell, including a substrate/cathode current collector (CCC) 110, a cathode layer 120, an electrolyte layer 130, an anode current collector (ACC) layer 140, and a patterned photomask 150. The patterned photomask 150 exposes an area 145a of the ACC layer 140 to be removed by dry (e.g., plasma-assisted) etching. During the etching process, a power bias forms between the cathode layer 120 and the anode layer 140 (e.g., in the etched area 145a), resulting in lithium ions 132a-c migrating from the cathode layer 120 and the electrolyte layer 130 to the ACC layer 140, where they eventually become exposed to the ambient environment and inactivated (e.g., by reacting with species such as ambient oxidants). As a result, the inactivated lithium ions are lost to the battery charging and discharging processes.

As an alternative, the ACC layer 140 can be patterned by laser ablation, without the use of a photomask. For example, light 160 from a laser can irradiate a predetermined location 145b of the ACC layer 140 to remove the ACC layer 140 in the location. However, the ACC layer 140 generally comprises an electrically conductive material, and electrically conductive materials also tend to be thermally conductive. This results in significant heat generation in the irradiated location 145b, some of which is inevitably transferred to the electrolyte layer 130. Excess heat can result in damage to the electrolyte layer 130, such as cracks 134. In some cases, the electrically conductive material of the ACC layer 140 fills the crack, and when the crack is sufficiently deep, a short circuit between the ACC layer 140 and the cathode layer 120 results. The short circuit results in a defective cell that cannot be used. However, even when a short circuit does not form, the damaged electrolyte layer 130 and any conductive material from the ACC layer 140 entering the damaged electrolyte layer 130 can cause parasitic leakage pathways in charging and discharging processes, both in single cells and in stacked battery cells.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY

The present disclosure relates to solid-state and thin-film batteries, and more specifically to a laser-patterned solid-state battery and methods of making the same. The present disclosure avoids the issues in the background art by forming a patterned insulating material in and/or under the electrolyte layer, in areas where an overlying ACC layer is to be patterned, then patterning a blanket ACC film by laser patterning and/or laser ablation. Besides achieving a dry, high-fidelity pattern with reduced (or no) damage to the underlying electrolyte, this approach is also advantageous for patterning flexibility, lower cost, and higher throughput, since the laser ablation pattern and process do not involve fabricating a physical mask (e.g., a photolithography or shadow mask).

Thus, in one aspect, the disclosure relates to a method of making solid-state battery cells, comprising forming a patterned insulator (e.g., forming an insulating material in a pattern) on a cathode layer on a substrate, blanket-depositing a solid-state electrolyte layer on the cathode layer and the patterned insulator, blanket-depositing an anode current collector (ACC) layer on the solid-state electrolyte layer, and laser-patterning the ACC layer over the patterned insulator (e.g., irradiating the ACC material with light from a laser in a pattern overlapping that of the patterned insulator to remove the ACC material) to form a plurality of anode current collectors (ACCs). The patterned insulator may define a border or boundary between adjacent solid-state battery cells, or correspond to interfaces between adjacent cells. Each ACC is in a corresponding one of the solid-state battery cells. The method may further comprise cleaning the laser-irradiated battery cells (e.g., the irradiated ACC and exposed areas of the electrolyte), encapsulating each of the battery cells with an encapsulant (optionally after cutting or dicing the battery cells), singulating the (encapsulated) battery cells, and/or packaging the singulated battery cells. The method may also further comprise stacking the singulated battery cells prior to packaging the cells.

The patterned insulator may be formed in the pattern by selective deposition (e.g., printing, such as screen printing or laser printing), or by blanket-depositing the insulating material (e.g., by chemical vapor deposition [CVD] or sol-gel processing) and photolithographic patterning. When the patterned insulator is formed by printing, printing may be followed by drying and curing or annealing the printed patterned insulator. In embodiments in which the patterned insulator is blanket-deposited, blanket-depositing the corresponding insulating material may comprise depositing the insulating material in a uniform or substantially uniform thickness and photolithographically patterning (e.g., using low-resolution photolithographic patterning) the insulating material to form the patterned insulator. In various embodiments, the patterned insulator comprises an inorganic insulator selected from silicon and/or aluminum oxides and/or nitrides (e.g., undoped silicon dioxide, silicon dioxide doped with one or more dopants selected from boron, phosphorous, fluorine, and/or carbon, a silicon oxynitride, etc.), or an insulating organic polymer, which may be heat-tolerant (e.g., parylene, a polyester, a polyamide or polyimide, etc.). The patterned insulator may have a width of 5-1000 μm, or any width or range of widths therein (e.g., 100-500 μm), but the disclosure is not limited to this range.

In most embodiments, the solid-state electrolyte layer contacts an exposed uppermost surface of the cathode layer and completely covers the patterned insulator. The solid-state electrolyte layer and the patterned insulator may each independently have a thickness of 0.2-2.0 μm, or any width or range of widths therein (e.g., 0.4-1.0 μm), and in some embodiments, the patterned insulator thickness may be less than the thickness of the solid-state electrolyte in a region in direct contact with the cathode layer.

In some embodiments of the method, the ACC layer is laser-patterned using a programmable laser patterning device. In such embodiments, the method may further comprise programming the programmable laser patterning device. For example, the programmable laser patterning device may be programmed to form polylines in the ACC layer. The polylines may comprise a first plurality of parallel lines along a first direction and a second plurality of parallel lines along a second direction. For example, the second direction may be orthogonal to the first direction. However, the first and second pluralities of parallel lines may not form sharp corners. In other or further examples, the first and second pluralities of parallel lines may have a width of 2-500 μm, or any width or range of widths therein (e.g., 10-100 μm), independent of each other (individually or as one of the pluralities, in which each of the first plurality of parallel lines has a first width, and each of the second plurality of parallel lines has a second width independent of the first width). In some embodiments, laser-patterning the ACC layer forms gaps having a width of 2-500 μm, or any width or range of widths therein (e.g., 10-100 μm), between adjacent ACCs. The ACC layer may be laser-patterned using light having a wavelength of 240-1400 nm, a pulse length of 5 femtoseconds to 1000 ns, a pulse frequency of 10⁵-10¹⁴ Hz, and/or a power of 10-1000 W.

In some embodiments, the ACC layer comprises a conductive metal, such as nickel, zinc, copper, tungsten, vanadium, an alloy of one or more of these metals, or graphite. When the ACC layer comprises or consists essentially of the conductive metal, the conductive metal is incapable of forming an alloy with lithium. The ACC layer may be deposited by spray coating, sputtering, evaporation, CVD, or ALD, and may have a thickness of 0.1-5 µm.

In some embodiments, the solid-state electrolyte comprises lithium phosphorus oxynitride (LiPON), carbon-doped LiPON, Li₂WO₄, or one or more layers of a lithium lanthanum zirconium oxide (LLZO), in which some of the Zr may be substituted with one or more of niobium, tantalum, aluminum, gallium, indium, vanadium, antimony, or hafnium. In other or further embodiments, blanket-depositing the solid-state electrolyte comprises depositing a LiPON layer or a tungsten oxide layer of the formula WO₃₊ₓ (0 ≤ x ≤ 1) by sputtering or atomic layer deposition (ALD), or depositing one or more LLZO layers by sol-gel techniques. When blanket-depositing the solid-state electrolyte comprises depositing the tungsten oxide layer, blanket-depositing the solid-state electrolyte may comprise sputtering using a metallic or elemental tungsten target in an oxygen-containing atmosphere to form the tungsten oxide layer, then lithiating and thermally annealing the tungsten oxide layer. In some embodiments, the method further comprises forming an interface material comprising a lithiated metal oxide on the cathode material and/or the solid-state electrolyte.

In some embodiments, the method further comprises blanket-depositing a cathode material on the substrate to form the cathode layer. The cathode material may comprise a lithium metal oxide or lithium metal phosphate, such as lithium cobalt oxide (LCO), lithium manganese oxide (LMO), or lithium iron phosphate (LFP). In other or further embodiments, blanket-depositing the cathode material may comprise laser deposition, sputtering, chemical vapor deposition (CVD), sol-gel processing, screen printing, inkjet printing, spray coating, or extrusion coating. Alternatively, the cathode layer (optionally in combination with the substrate) may comprise a lithium metal oxide or lithium metal phosphate ceramic sheet.

In some embodiments, the substrate comprises a metal foil. For example, the metal foil may function as a cathode current collector in each of the battery cells. In such embodiments, the method may further comprise forming a diffusion barrier on one or both major surfaces of the metal foil prior to blanket-depositing the cathode material. In various examples, the metal foil comprises elemental aluminum, copper, titanium, nickel, iron, or an alloy thereof (e.g., stainless steel). For example, the metal foil may have a thickness of 10-100 μm. In embodiments including the diffusion barrier, the method may further comprise depositing an insulation layer, such as a silicon oxide, on the diffusion barrier. Thus, in some embodiments, the diffusion barrier may comprise a metal nitride or a combination of the metal nitride and an insulation layer (e.g., alternating metal nitride diffusion barrier and silicon oxide insulation layers).

In embodiments of the method that further comprise encapsulating the battery cells, the battery cells may be encapsulated by forming or depositing the encapsulant on the laser-patterned ACC and along the ACC edges or sidewalls of the cells, and may further comprise forming (or leaving) an opening in the encapsulant exposing the ACC. In some embodiments, encapsulating each of the battery cells comprises inkjet printing or screen printing the encapsulant onto the battery cells (e.g., the ACC and the ACC edges or sidewalls) in a pattern including the opening. In other embodiments, encapsulating each of the laser-patterned battery cells may comprise coating or blanket-depositing the encapsulant onto the battery cells, and patterning the coated or blanket-deposited encapsulant to form the opening. Typically, the encapsulant comprises a moisture barrier and/or electrical insulation film. For example, the encapsulant may comprise a polyolefin (which may be moisture-repellent or moisture-resistant).

In some embodiments, the method further comprises forming a redistribution layer on the ACC and, when present, the encapsulant. When the encapsulant is present, the redistribution layer is formed on the ACC exposed through the opening, and when the encapsulant is along the ACC edge or sidewall, the redistribution layer may also be formed on the encapsulant along the ACC edge or sidewall. In some embodiments, the redistribution layer comprises an elemental metal or an alloy thereof (e.g., an alloy consisting essentially of elemental metals). In various embodiments, the redistribution layer is formed by sputtering, atomic layer deposition (ALD), or thermal evaporation, followed by photolithographic patterning and etching. Alternatively, the redistribution layer may be formed by selective deposition, such as inkjet printing, aerosol-jet printing, or screen printing. In certain embodiments, the redistribution layer has a thickness of 0.25-2.0 μm.

The method may further comprise cutting or dicing the solid-state battery cells through the electrolyte layer, the patterned insulator, and the cathode layer (e.g., in or along at least part of the pattern of the patterned insulator) to form a cathode in each of the solid-state battery cells and/or to singulate the solid-state battery cells. In some embodiments of the method, singulating the (encapsulated) battery cells comprises laser dicing, mechanical dicing, or stamping. For example, singulating the battery cells may comprise cutting or dicing the cells through the patterned insulator, the cathode layer, and the substrate to expose an ACC edge or sidewall of the solid-state battery cells (optionally prior to encapsulating the cells). In some further embodiments, the battery cells are cut or diced every other cell (or every other row or column of cells), which may form dual or paired cells, or dual rows or columns of cells. The method may also further comprise cutting or dicing the dual/paired cells or dual rows or columns of cells (in or along another part of the pattern of the patterned insulator) through the encapsulant, the patterned insulator, the cathode layer, and the substrate to form CCC edges or sidewalls of the battery cells. The CCC edges or sidewalls of the battery cells are generally opposite to the ACC edge or sidewall (on which the redistribution layer is formed).

In further embodiments, the method may further comprise stacking and/or packaging the singulated battery cells. The singulated battery cells may, in some embodiments, comprise singulated rows or columns of the battery cells. The stacked battery cells may have all of the ACC edges or sidewalls on a first side of the stacked battery cells, and all of the CCC edges or sidewalls on a second side of the stacked battery cells.

In some embodiments, stacking the singulated battery cells comprises depositing an adhesive (e.g., an epoxy adhesive) on a first one of the singulated battery cells, and placing a next one of the singulated battery cells on the first one of the singulated battery cells. Optionally, the method may further comprise stacking one or more of the singulated battery cells on the next one of the singulated battery cells until the last one of the singulated battery cells is stacked. In other or further embodiments, stacking the singulated battery cells further comprises placing a dummy cell on the last one of the singulated battery cells. In various embodiments, placing the next one of the singulated battery cells on the first one of the singulated battery cells comprises a pick-and-place operation. In other embodiments, when the singulated battery cells comprise a row or column of cells, stacking the singulated battery cells may comprise strip folding or strip stacking the row or column of cells.

In another aspect, the disclosure relates to a solid-state battery cell, comprising a cathode, a patterned insulator thereon, a solid-state electrolyte on the cathode and covering the patterned insulating material, and a laser-patterned anode current collector (ACC) on the solid-state electrolyte. The electrolyte, the patterned insulator, and the cathode are co-extensive (i.e., have the same width, the same length, and aligned sidewalls), and the sidewalls of the electrolyte and the cathode are separated by the patterned insulator. Thus, the patterned insulator may be along a border or boundary (e.g., an outermost periphery) of the solid-state battery cell. In most embodiments, the patterned insulator is along the entire border, boundary, or outermost periphery of the solid-state battery cell. Thus, the solid-state electrolyte layer may completely cover the patterned insulator and may contact an exposed uppermost surface of the cathode.

Compared to a photolithographically-patterned ACC having otherwise identical properties and characteristics, the laser-patterned ACC has peripheral edges or sidewalls with a greater variance (e.g., from linearity and/or planarity) and sharper uppermost edges (i.e., the angles between the major surface away from the electrolyte and the sidewalls). Compared to a printed ACC having otherwise identical properties and characteristics, the laser-patterned ACC has greater purity and/or better electrical properties.

The present solid-state battery cell may further comprise any of the other structures and materials described herein. For example, the solid-state battery cell may, in some embodiments, further comprise (1) an encapsulant on the ACC and at least an ACC sidewall of the electrolyte, the patterned insulator and the cathode, (2) a redistribution layer on the encapsulant and along the ACC sidewall, in electrical contact with the ACC (e.g., in an opening in the encapsulant, exposing the ACC), and/or (3) a cathode current collector (CCC) having a CCC contact. In the latter embodiment(s), the patterned insulator and the encapsulant may be along an outermost periphery of the solid-state battery cell above the CCC contact.

As for the present method, the patterned insulator may have a thickness less than the thickness of the solid-state electrolyte in a region in direct contact with the cathode, and the patterned insulator may comprise an inorganic insulator selected from silicon and/or aluminum oxides and/or nitrides or an insulating (and optionally heat-resistant) organic polymer.

In some embodiments of the present solid-state battery cell, the ACC has area dimensions (e.g., a length and width) that are 75-98% of corresponding area dimensions of the solid-state battery cell. In other or further embodiments, the patterned insulator may have a width of 1.5-250 μm, or any width or range of widths therein (e.g., 10-100 μm).

In certain embodiments of the solid-state battery cell, the substrate comprises a metal foil that functions as the cathode current collector. The metal foil may comprise elemental aluminum, copper, titanium, nickel, iron, or an alloy thereof, and may have a thickness of 10-100 μm. In further embodiments, the metal foil may further comprise a diffusion barrier on one or both major surfaces thereof, and the cathode may be on the diffusion barrier.

In various embodiments, (i) the cathode comprises a lithium metal oxide or lithium metal phosphate, (ii) the ACC comprises graphite or a conductive metal incapable of forming an alloy with lithium, (iii) the solid-state electrolyte comprises lithium phosphorus oxynitride (LiPON), carbon-doped LiPON, Li₂WO₄, or one or more layers of a lithium lanthanum zirconium oxide (LLZO) in which some of the zirconium may be substituted with one or more of niobium, tantalum, aluminum, gallium, indium, vanadium, antimony or hafnium, and/or (iv) the redistribution layer comprises an elemental metal or an alloy consisting essentially of elemental metals. The ACC may have a thickness of 0.1-5 µm, and the redistribution layer may have a thickness of 0.25-2.0 μm.

The present solid-state battery cell may further comprise a cathode current collector (CCC) contact on a side or edge of the solid-state battery cell opposite from the ACC sidewall. As for the present method, in embodiments in which the substrate comprises a metal foil functioning as a CCC, the exposed edge or sidewall of the metal foil may function as the CCC contact.

Another aspect of the present disclosure concerns a solid-state battery comprising a plurality of the present solid-state battery cells, stacked so that the ACC sidewalls are on a first side of the stacked battery cells, and the CCC contacts are on the opposite side of the stacked battery cells.

Other capabilities and advantages of the present disclosure will become readily apparent from the detailed description of various embodiments below.

### BRIEF DESCRIPTION OF THE DRAWINGS

FIG. 1 is a cross-sectional view of a structure showing certain problems that can arise in conventional methods of manufacturing solid-state battery cells.

FIG. 2 is a cross-sectional view of an exemplary structure of a laser-patterned solid-state battery cell, according to some examples.

FIGS. 3-5, 6A, 7-8, 9A, 10A, 11A, 12A, and 13A are cross-sectional views of various structures in an exemplary method of laser-patterning solid-state battery cells, according to some examples.

FIGS. 6B, 9B, 10B, 11B, 12B, and 13B are layout (top-down) views of the structures shown in FIGS. 6A, 9A, 10A, 11A, 12A, and 13A, according to some examples, zoomed out to show a larger structure.

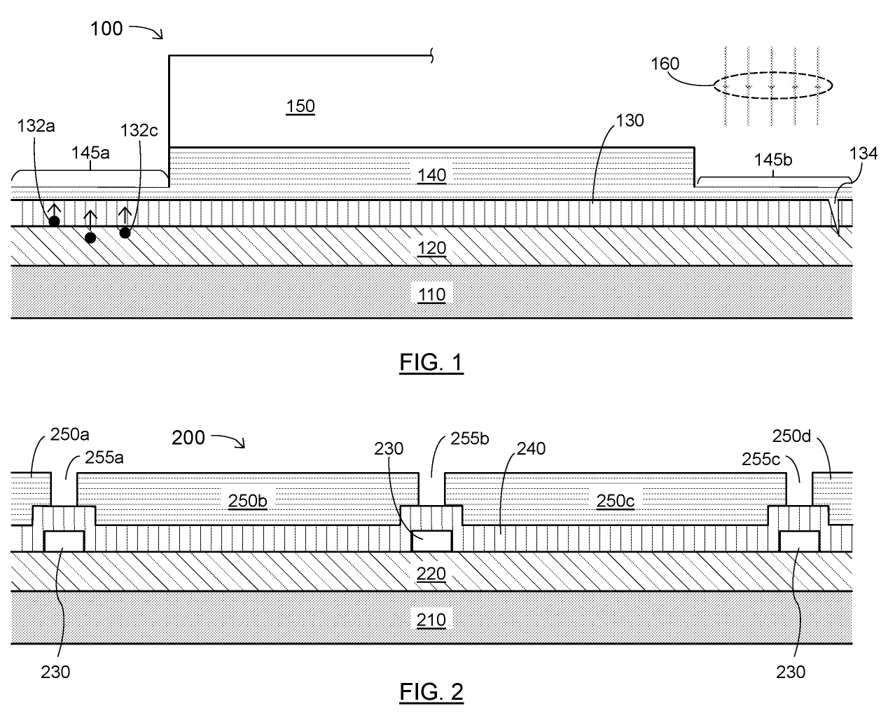

### DETAILED DESCRIPTION

Reference will now be made in detail to various embodiments of the disclosure, examples of which are illustrated in the accompanying drawings. While the disclosure will be described in conjunction with the following embodiments, it will be understood that the descriptions are not intended to limit the disclosure to these embodiments. On the contrary, the disclosure is intended to cover alternatives, modifications, and equivalents that may be included within the spirit and scope of the disclosure. Furthermore, in the following detailed description, numerous specific details are set forth in order to provide a thorough understanding of the present disclosure. However, it will be readily apparent to one skilled in the art that the present disclosure may be practiced without these specific details. In other instances, well-known methods, procedures, and components have not been described in detail so as not to unnecessarily obscure aspects of the present disclosure. Furthermore, it should be understood that the possible permutations and combinations described herein are not meant to limit the disclosure. Specifically, variations that are not inconsistent may be mixed and matched as desired.

The technical proposal(s) of embodiments of the present disclosure will be fully and clearly described in conjunction with the drawings in the following embodiments. It will be understood that the descriptions are not intended to limit the disclosure to these embodiments. Based on the described embodiments of the present disclosure, other embodiments can be obtained by one skilled in the art without creative contribution and are in the scope of legal protection given to the present disclosure.

Furthermore, all characteristics, measures, or processes disclosed in this document, except characteristics and/or processes that are mutually exclusive, can be combined in any manner and in any combination possible. Any characteristic disclosed in the present specification, claims, Abstract, and Figures can be replaced by other equivalent characteristics or characteristics with similar objectives, purposes, and/or functions, unless specified otherwise.

For the sake of convenience and simplicity, the term “length” generally refers to the largest dimension of a given 3-dimensional structure or feature. The term “width” generally refers to the second largest dimension of a given 3-dimensional structure or feature. The term “thickness” generally refers to the smallest dimension of a given 3-dimensional structure or feature. The length and the width, or the width and the thickness, may be the same in some cases. A “major surface” refers to a surface defined by the two largest dimensions of a given structure or feature, which, in the case of a structure or feature having a circular surface, may be defined by the radius of the circle.

In addition, for convenience and simplicity, the terms “part,” “portion,” and “region” may be used interchangeably, but these terms are also generally given their art-recognized meanings. Also, unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

The present disclosure concerns a solid-state battery containing a printed encapsulation and/or redistribution layer and methods of making the same. The present solid-state battery includes, in some embodiments, an intrinsic anode-less battery comprising a substrate (which can also serve or function as a cathode current collector [CCC]), a cathode or cathode layer, a solid-state electrolyte (SSE) or solid-state electrolyte layer, and an anode current collector (ACC). In anode-less embodiments, no lithium anode is formed between the SSE and the ACC during manufacturing. A lithium anode may form during or upon completion of a battery charging operation.

The following discussion provides an example of a manufacturing process for solid-state batteries and stacked solid-state batteries, as well as variations of the process.

FIG. 2 is a cross-sectional view showing an exemplary structure for a plurality of laser-patterned solid-state battery cells 200, including a substrate 210, a cathode 220 thereon, a patterned insulator 230 on the cathode 220, a solid-state electrolyte 240 on the cathode 220 and the patterned insulator 230, and a plurality of anode current collectors (ACCs) 250a-d on the solid-state electrolyte 240. The ACCs 250a-d correspond to individual battery cells, and the patterned insulating 230 is in locations corresponding to borders, boundaries, or interfaces between adjacent battery cells.

The patterned insulator 230 insulates the cathode 220 from thermally-induced shorts and leaks in the solid-state electrolyte 240. In some cases (e.g., when the electrolyte 240 is deposited by sol-gel processing or is planarized, e.g., by polishing), the patterned insulator 230 reduces the thickness of the solid-state electrolyte 240 under the regions of the ACC layer that are patterned by laser irradiation. The patterned insulator 230 generally has a thickness less than that of the solid-state electrolyte 240. For example, the patterned insulator 230 may have a thickness that is 50-90% of the thickness of the solid-state electrolyte 240 (or any percentage or range of percentages therein), but the disclosure is not necessarily limited to this range.

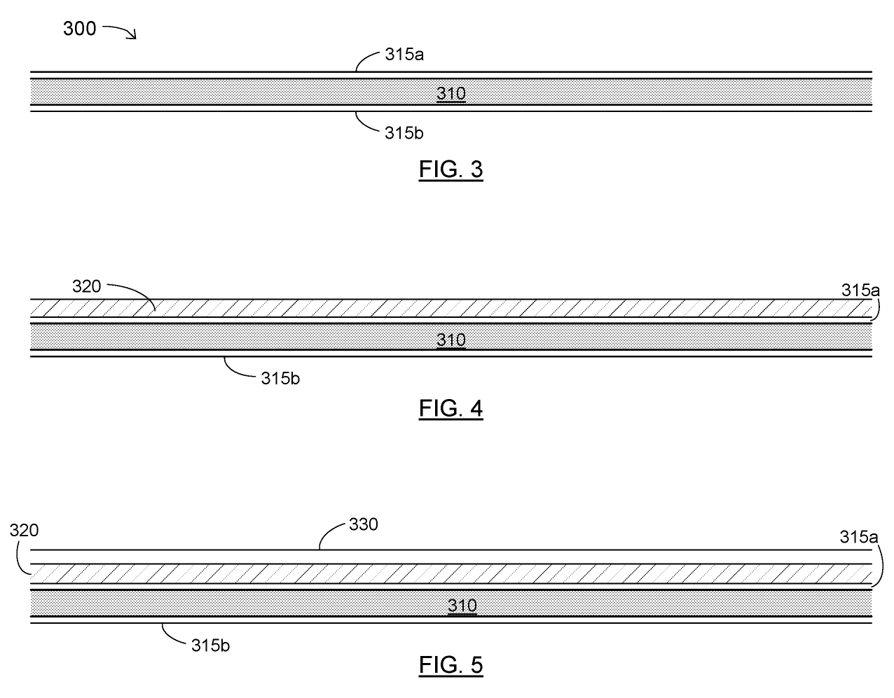

The ACCs 250a-d are separated by gaps 255a-c, formed by laser irradiation (patterning). The gaps 255a-c may have a width of 2-500 μm, or any width or range of widths therein, but the disclosure is not limited to this range. For example, the gaps 255a-c may have a width greater than 500 μm when the lines of the patterned insulator 230 have an average width of 1000 μm or more. The pattern (e.g., the lines) in the patterned insulator 230 generally has a width greater than that of the gaps 255a-c. For example, the patterned lines in the patterned insulator 230 may have a width of 2-500 μm + nδ, where δ is a standard margin of error for the width of the gaps 255a-c in the laser patterning process, and n is a number > 2 (e.g., 4 or more). As shown in FIG. 2, the ACC layer prior to formation of the gaps 255a-c is planarized, which may facilitate subsequent processing by reducing variances in topography, and which may reduce local electrical field maxima by reducing the number of bends and corners in the ACCs 250a-d. However, in a simplified process (discussed below with regard to FIGS. 3-13B), the ACC layer can be conformal over the solid-state electrolyte 240.

FIGS. 3-5, 6A-6B, 7-8, 9A-9B, and 10A-10B show certain structures in an exemplary method of making a solid-state battery in accordance with the present disclosure. FIG. 3 shows a substrate 300, comprising a metal foil, sheet, or film 310 and optional first and second barriers 315a-b on opposite major surfaces of the metal foil, sheet, or film 310. When the foil, sheet, or film 310 is a metal foil, the first barrier 315a is not optional. The metal foil may comprise or consist essentially of stainless steel, aluminum, copper, nickel, inconel, brass, molybdenum or titanium, the elemental metals of which may be alloyed with up to 10% of one or more other elements to improve one or more physical and/or chemical properties thereof (e.g., oxygen and/or water permeability, flexibility, resistance to corrosion or chemical attack during subsequent processing, etc.). However, the substrate 300 can also be a metal sheet or a metal roll. For example, the foil or film may be 10-100 µm thick, whereas a metal sheet may have a thickness of > 100 µm, up to about 1-2 mm, although the disclosure is not so limited. Other alternative substrates include a metal coating on a mechanical substrate, such as aluminum, copper, nickel, titanium, etc., on a removable plastic film, sheet, or roll.

The barrier 315a-b comprises one or more layers of one or more materials in a thickness effective to prevent migration of atoms or ions from the metal foil, sheet, or film 310 into overlying layers. The barrier material(s) may comprise a glass or ceramic, such as silicon dioxide, aluminum oxide, silicon nitride, a silicon and/or aluminum oxynitride, etc., or a (refractory) metal nitride, such as aluminum nitride, titanium nitride, titanium aluminum nitride, tungsten nitride, titanium tungsten nitride, TiW alloy, tantalum nitride, etc. In some embodiments, each of the first and second barriers 315a-b comprises alternating glass/ceramic and metal nitride layers (e.g., a first metal nitride layer, a first glass/ceramic layer, and a second metal nitride layer, which may further comprise a second glass/ceramic layer, a third metal nitride layer, etc.). Each barrier 315a or 315b may have a total thickness of 0.05-3 µm, but the barrier 315a-b is not limited to this range. The barriers 315a-b may be blanket-deposited onto the foil, sheet or film 310 by chemical or physical vapor deposition (e.g., sputtering, thermal evaporation, atomic layer deposition [ALD], etc.), solution-phase coating with a precursor material followed by annealing to form the glass/ceramic or metal nitride, etc. Exemplary barrier materials, structures, and thicknesses and methods for their deposition are disclosed in U.S. Pat. Nos. 9,299,845 and 11,742,363, the relevant portions of each of which are incorporated by reference herein.

In some embodiments, the foil, sheet, or film 310 functions as a cathode current collector. In such embodiments, at least the barrier 315a (and optionally the barrier 315b) is or includes a conductive, amorphous material, such as the refractory metal nitrides listed above or an amorphous metal alloy (e.g., a TiW alloy).

FIG. 4 shows the metal substrate 300 with a cathode layer 320 thereon. The cathode layer 320 may comprise a lithium metal oxide or lithium metal phosphate, such as lithium cobalt oxide (LiCoO₂; LCO), lithium manganese oxide (LiMn₂O₄; LMO), or lithium iron phosphate (LiFePO₄; LFP), for example. The cathode layer 320 may be blanket deposited by laser deposition (e.g., pulsed laser deposition or PLD), sputtering, chemical vapor deposition (CVD), sol-gel processing, etc. Alternatively, the cathode layer 320 may be selectively deposited by screen printing, inkjet printing, spray coating, or extrusion coating (e.g., using an ink comprising one or more sol-gel precursors and one or more solvents, having a viscosity appropriate for the printing or coating technique). After deposition, the cathode layer 320 may be annealed (e.g., at a temperature of 500-800 °C, or any temperature or range of temperatures therein) for a length of time sufficient to achieve a predetermined or desired crystalline structure.

Alternatively, the cathode layer 320 (typically in combination with the substrate 300) may comprise a lithium metal oxide or lithium metal phosphate ceramic sheet. Such ceramic sheets may be on a backing material (e.g., a polymeric tape), and thus be transferable, and may have a width similar to or identical to a sheet or roll of the substrate 300. Such lithium metal oxide and lithium metal phosphate ceramic sheets may have a thickness of 15-50 μm, or any value or range of values therein. and are commercially available from NEI Corporation (Somerset, NJ), Targray (Kirkland, Canada), and MSE Supplies (Tucson, AZ). The sheet may be adhered to the substrate 300 using a thin layer (e.g., 300 Å – 2 μm) of an elemental metal, such as aluminum or titanium, or an electrically conductive alloy, such as a conventional tin solder. Thus, the present method may further comprise blanket-depositing an elemental metal or an electrically conductive alloy onto the substrate 300, then placing (and optionally pressing, with further optional application of heat) the cathode layer 320 onto the elemental metal or electrically conductive alloy.

FIG. 5 shows the structure of FIG. 4 with an insulator layer 330 blanket-deposited thereon. The insulator layer 330 can be blanket-deposited by chemical vapor deposition (CVD, for example, plasma-enhanced chemical vapor deposition [PECVD]), sol-gel coating, extrusion coating, sputtering, etc. The insulator layer 330 may comprise an inorganic insulator, such as a silicon and/or aluminum oxide and/or nitride (e.g., SiO₂, a silicon oxynitride, an aluminum oxide, etc.) or an organic insulator (e.g., an insulating polymer such as a polyimide, polyethylene, polyvinylchloride, an organosiloxane polymer such as poly(dimethylsiloxane), etc.). The insulator layer 330 typically does not include any material that is an ionic conductor (e.g., a conductor of Li⁺ ions).

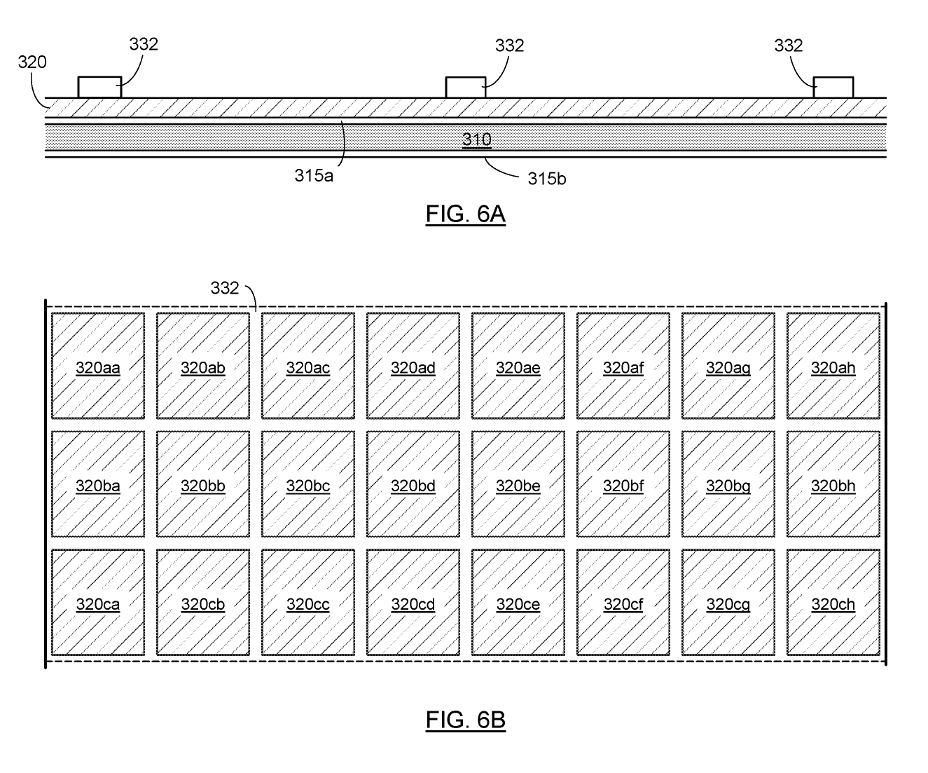

FIG. 6A shows a cross-section of the structure of FIG. 4 with the patterned insulator layer 332 on the cathode layer 320. FIG. 6B shows a layout view of a partial sheet or roll, with the patterned insulator layer 332 on the cathode layer 320. The patterned insulator layer 332 essentially defines the individual areas of an array of battery cells 320aa-ch. The patterned insulator layer 332 can be made by photolithographically patterning the insulator layer 330 (e.g., coating a photoresist on the insulator layer 330, irradiating selected portions of the photoresist, developing the photoresist to expose the portions of the insulator layer 330 to be removed, removing the exposed portions of the insulator layer 330 by etching, removing the remaining photoresist by ashing, and optionally cleaning the resulting structure shown in FIG. 6A). Alternatively, the patterned insulator layer 332 can be formed on the cathode layer 320 directly by printing (e.g., inkjet printing, screen printing, etc.), followed by curing or annealing, if necessary or desired. The patterned insulator layer 332 may have line widths and a thickness as disclosed herein (e.g., a width of 20-1000 μm, or any value or range of values therein, and a thickness of 0.2-1.0 μm, or any value or range of values therein).

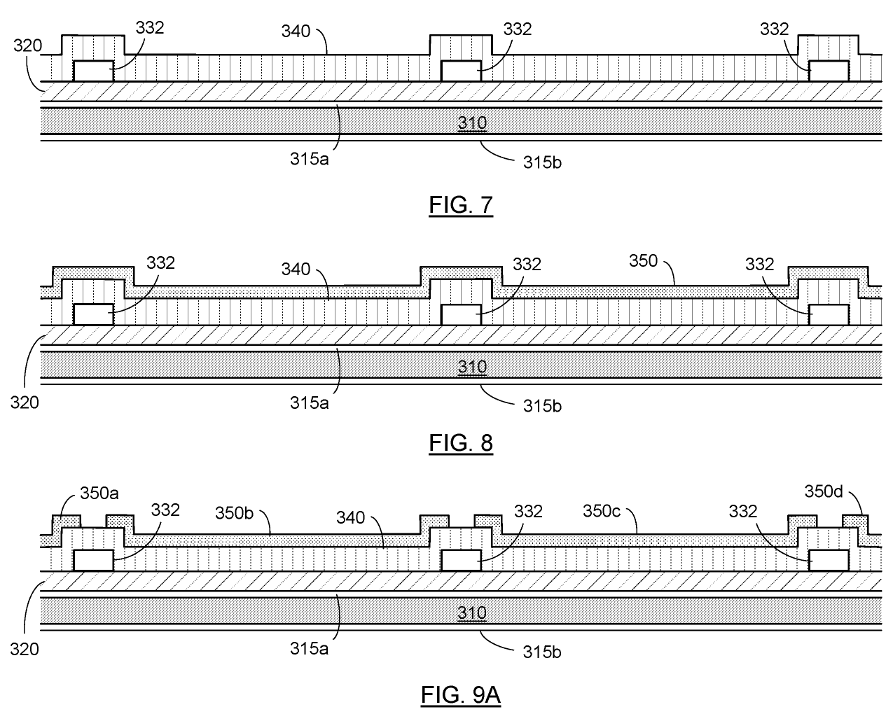

The patterned insulator layer 332 prevents potential damage to the to-be-formed solid-state electrolyte and the interface between the cathode layer 320 and the electrolyte from heat generated during laser patterning, allowing the to-be-formed ACC to be patterned by laser ablation. Placing the patterned insulator layer 332 between the electrolyte layer (to be formed; see FIG. 7) and the cathode layer 320 prevents (1) formation of electronic leakage paths (e.g., between the cathode and the subsequently-formed ACC) and (2) transport of ions between the cathode and the ACC. In the absence of the patterned insulator layer 332, the electronic leakage paths and ionic transport can be caused by heat, plasma, or other localized damage induced during patterning.

FIG. 7 shows a solid-state electrolyte layer 340 on the cathode layer 320 and the patterned insulator layer 332. The solid-state electrolyte layer 340 may comprise or consist essentially of a conventional lithium phosphorus oxynitride (LiPON, which may optionally be carbon-doped) or Li₂WO₄, a good Li-ion conductor. Alternatively, the solid-state electrolyte layer 340 may comprise or consist essentially of one or more layers of a lithium lanthanum zirconium oxide (LLZO; e.g., Li₇La₃Zr₂O₁₂ in which some of the Zr may be substituted with one or more of niobium, tantalum, aluminum, gallium, indium, vanadium, antimony, or hafnium) or other garnet-type oxide electrolyte. Further, alternative solid-state electrolyte layer 340 may comprise or consist essentially of a NASICON (sodium superionic conductor), a sulfide-based inorganic electrolyte, a LISICON (lithium superionic conductor), or a solid inorganic-polymer composite electrolyte including one or more of the inorganic electrolytes mentioned herein.

In some embodiments, the solid-state electrolyte layer 340 may further comprise optional cathode and/or anode interface layers (not shown), each of which may comprise a lithiated metal oxide. For example, a metal oxide (e.g., NbO₂, Al₂O₃, Li₄Ti₅O_{12,} or LiNbO₃) interlayer may be formed on the cathode layer 320 (and optionally on the patterned insulator layer 332) prior to deposition of the solid-state electrolyte layer 340 (e.g., to reduce interfacial stress, decrease interfacial resistance, or suppress formation of a space charge layer). Alternatively or additionally, an amorphous (e.g., elemental silicon) interlayer may be deposited on the solid-state electrolyte layer 340 (and optionally on the patterned insulator layer 332) prior to formation of the anode current collector layer 350 to inhibit reduction of the solid-state electrolyte layer 340. In some embodiments, thermal annealing can modify the interface(s) between the layers of the cell, which can significantly reduce charge transfer resistance.

Forming the solid-state electrolyte layer 340 may comprise depositing a LiPON layer or a tungsten oxide layer of the formula WO₃₊ₓ (0 ≤ x ≤ 1) by sputtering, optionally using pulsed DC power. When the solid-state electrolyte layer 340 comprises LiPON, it may be deposited by RF sputtering or ALD. The sputtering target may comprise a Li₃PO₄ or mixed graphite-Li₃PO₄ target, the latter of which may contain 1-15 wt% of graphite, when the solid-state electrolyte layer 340 comprises LiPON or carbon-doped LiPON, and a metallic/elemental tungsten target when the solid-state electrolyte layer 340 comprises a tungsten oxide. In the latter case, sputtering is performed in an oxygen or oxygen-containing atmosphere. Such deposition techniques generally result in a conformal solid-state electrolyte layer 340, as shown in FIG. 7.

The method of making the solid-state electrolyte layer 340 may further comprise lithiating and thermally annealing the WO₃₊ₓ, which can transform it into Li₂WO₄, a good Li-ion conductor. Lithiating may comprise wet lithiation (e.g., immersing the WO₃₊ₓ in a solution containing a lithium electrolyte such as LiClO₄, LiPF₆, LiBF₄, etc., and applying an appropriate electric field) or dry lithiation (e.g., sputtering or thermally evaporating elemental lithium onto the tungsten oxide in a vacuum chamber, optionally while heating the substrate 300). Thermal annealing may comprise heating at a temperature of 150-500 °C for a length of time of 5-240 minutes, or any temperature or length of time therein (e.g., 250-450 °C for 10-120 minutes), in a conventional oven, a vacuum oven, or a furnace. To ensure substantially complete diffusion of the lithium into and/or throughout the WO₃₊ₓ, the WO₃₊ₓ should be annealed (preferably in air) at a temperature of at least 100 °C for at least 10 minutes (e.g., to transform it into Li₂WO₄).

An LLZO-containing solid-state electrolyte layer 340 may be formed by depositing an LLZO sol-gel (e.g., by spic-coating, extrusion coating, dip-coating, drip-casting, etc.), then annealing at a temperature in the range of 500-800 °C, or any value or range of values therein for 1-60 minutes in an oxygen-containing gas such as clean dry air (CDA).

The sol-gel method of forming the solid-state electrolyte layer 340 has the advantage of forming a solid-state electrolyte layer 340 with a planar or substantially planar uppermost surface. When the solid-state electrolyte layer 340 is deposited by sputtering, CVD, or ALD, the deposited electrolyte material may be planarized (e.g., by polishing, such as chemical mechanical polishing) to form a planar solid-state electrolyte layer 340. Thus, in some embodiments, the patterned insulator layer 332 and the solid-state electrolyte layer 340 thereover may have a combined thickness equal to or substantially equal to a thickness of the solid-state electrolyte layer 340 outside of the patterned insulator (e.g., where the solid-state electrolyte directly contacts the cathode layer).

FIG. 8 shows an anode current collector layer 350 (ACC layer) blanket-deposited on the solid-state electrolyte layer 340 (not to the same scale as shown in FIG. 2). A separately-formed anode is not necessary in solid-state lithium batteries, as a lithium anode can be formed between the solid-state electrolyte layer 340 and the anode current collector layer 350 during charging, if necessary. Optionally, however, a thin lithium anode can be deposited by evaporation onto the solid-state electrolyte layer 340 prior to formation of the anode current collector layer 350. Alternatively, a thin silicon seed layer may be blanket-deposited onto the solid-state electrolyte layer 340 prior to deposition of the anode current collector layer 350. The silicon seed layer may be deposited by chemical vapor deposition (CVD; e.g., from silane gas), atomic layer deposition (ALD), coating from a liquid-phase silane such as trisilane, tetrasilane, cyclopentasilane, etc. The silicon seed layer may have a thickness of from 20 to 500 Å or any thickness or range of thicknesses therein (e.g., 50-200 Å).

The anode current collector layer 350 generally comprises a conductive metal, such as nickel, zinc, copper, tungsten, vanadium, alloys thereof (e.g., NiTi, NiV), etc., or another conductor, such as graphite. Preferably, the conductive metal for the anode current collector layer 350 is incapable of forming an alloy with lithium (e.g., a non-Li alloying metal or alloy). The anode current collector layer 350 can be deposited by spray coating or other blanket deposition technique (e.g., sputtering, evaporation, chemical vapor deposition (CVD), or atomic layer deposition [ALD]). The anode current collector layer 350 may have a thickness of 0.1-5 µm, although it is not limited to this range.

The battery may further include one or more interlayers that modify the interfaces between different functional layers. For example, a metal oxide (e.g., Nb₂O₅, Al₂O₃, Li₄Ti₅O_{12,} or LiNbO₃) interlayer may be formed on the cathode layer 320 prior to deposition of the solid-state electrolyte layer 340 (e.g., to reduce interfacial stress, decrease interfacial resistance, or suppress formation of a space charge layer). An amorphous (e.g., elemental silicon) interlayer may be deposited on the solid-state electrolyte layer 340 prior to formation of the anode current collector layer 350 to inhibit reduction of the electrolyte. Of course, the battery cell can be made in the reverse order (i.e., the anode current collector may be first formed on the substrate, then the remaining layers deposited in reverse order thereon).

An advantage of the present method is that all of the active battery layers (e.g., the cathode layer 320, the solid-state electrolyte layer 340, and the anode current collector layer 350) are deposited as blanket layers. This maximizes the active area utilization of the battery cells for high intrinsic capacity, and in some embodiments, results in a topographically planar or “flat” cell to facilitate formation of the uppermost layer(s) and downstream packaging due to the pattern-free blanket-deposited layers.

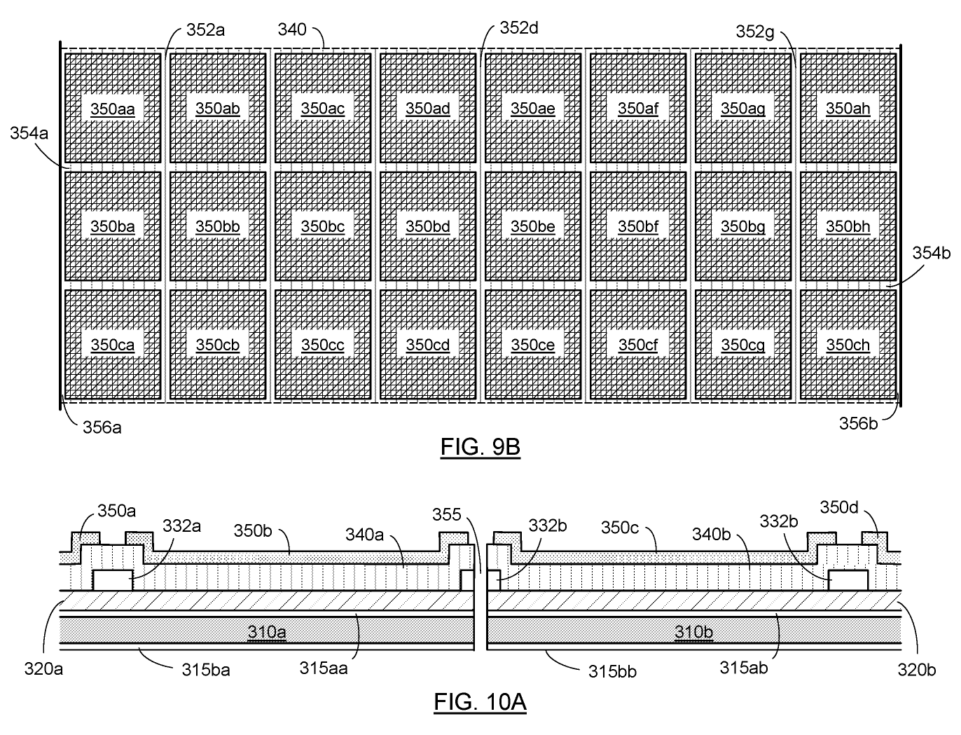

FIG. 9A shows a cross-section of anode current collectors (ACCs) 350a-d after laser patterning and/or laser ablation, and FIG. 9B shows a layout view of patterned ACCs 350aa-ch on the planar / substantially planar solid-state electrolyte layer 340, on a partial substrate in the form of a sheet or roll. In various embodiments, the ACC material is laser-patterned using light having a wavelength of 240-1400 nm, a pulse length of 5 femtoseconds to 1000 ns, a pulse frequency of 10⁵-10¹⁴ Hz, and/or a power of 10-1000 W, although the disclosure is not limited to these ranges.

Typically, an ablation pattern (e.g., a graphical drawing representing the areas of the blanket-deposited anode current collector layer 350 to be removed) is created and run on a programmable laser patterning device. The drawing may consist of a series of polylines (e.g., a first plurality of parallel lines 352a-g spaced apart by a first distance, and a second plurality of parallel lines 354a-b orthogonal to the first plurality of parallel lines 352a-g, spaced apart by a second distance the same as or different from the first distance) at an optimized spacing to form cleanly ablated regions outside of the desired remaining pattern of anode current collector layers (e.g., anode current collector layers 350aa-ch in FIG. 9B). Depending on parameters and conditions of deposition of the anode current collector layers 350, additional lines 356a and 356b along the periphery of the sheet or roll may also be laser-patterned, at least in part to ensure pull-back of the patterned anode current collector layers 350aa, 350ah, 350ba, 350bh, 350ca and 350ch from the edge of the sheet or roll and/or to ensure that the patterned anode current collector layers 350aa, 350ah, 350ba, 350bh, 350ca and 350ch have a more linear and/or vertical sidewall along the edge of the sheet or roll.

In a representative example, the graphical drawing is in a format used by laser patterning or ablation tools, such as an Autocad.dxf or .dwg file. The graphical drawing comprises or consists of a series of polylines having a width that may be optimized for a given laser tool. In some embodiments, the polylines exclude sharp corners (e.g., angles between crossing, consecutive, or adjacent lines that have an angle therebetween of 90° or less), to reduce or minimize electric field concentration at such corners, which may adversely affect battery cycling and/or battery lifetimes. Thus, laser patterning the anode current collector layer 350 enables corner rounding of the anode current collector layers 350aa-ch in each cell. Because there is no need for a mask, the ultimate shape of the anode current collector layers 350a-d (FIG. 9A) or 350aa-ch (FIG. 9B) is somewhat arbitrary, and can be any shape that can be formed using a conventional laser patterning or laser ablation tool.

The laser beam profile is typically Gaussian or top hat, depending on the target profile for material removal. The line widths may be in the range of 2-500 µm (or any width or range of widths therein, such as, e.g., 10-200 µm), depending on the laser beam spot size and energy profile, and the desired separation between adjacent ACCs for subsequent processing. For example, the full width at half-maximum power (or half-power beam width) of the laser beam may be in the range of 2-50 µm, but it can be adjusted (increased or decreased) using focusing lenses.

The laser power and scan parameters may be optimized for a given laser wavelength and desired ablation depth. For example, the laser wavelength may range from infrared or red (e.g., 800-1400 nm) to ultraviolet (e.g., 240-400 nm), although the disclosure is not limited to such ranges. The pulse length of the laser can be nanosecond (e.g., 1-1000 ns, or any value or range of values therein), picosecond (e.g., 5-1000 ps, or any value or range of values therein), or femtosecond (e.g., 5-5000 femtoseconds, or any value or range of values therein), although the disclosure is not limited to such pulse length ranges. In working examples using an IR laser (e.g., wavelength in the range of 800-1400 nm), when the pulse length is in the femtosecond range, the pulse frequency may be in the range of 10⁹-10¹⁴ Hz (or any value or range of values therein), and when the pulse length is in the nanosecond range, the pulse frequency may be in the range of 10⁵-10⁹ Hz, or any value or range of values therein. In any case, the laser power may be in the range of 10-1000 W, or any value or range of values therein. However, the disclosure is not limited to such ranges or values, and can be easily extended to other frequencies, pulse lengths, and wavelengths. One skilled in the art is capable of determining laser parameters that provide selectivity for the removal of the ACC material relative to the electrolyte material.

Referring to FIG. 9A (a cross-sectional view of the battery structure following laser patterning/ablation along at least one dimension of the substrate 300), anode current collector layers 350a-d for cells in different columns on the substrate are shown. Substantially all of the anode current collector layer 350 between adjacent anode current collector layers 350a-d is removed, but preferably, minimal solid-state electrolyte layer 340 is removed.

FIG. 9B is a plan or top-down view of the battery structure of FIG. 9A expanded across a width dimension of the substrate, following laser patterning along two orthogonal dimensions (e.g., length and width) of the substrate 300. Anode current collector layers 350aa-ch correspond to individual battery cells, and are separated from each other by gaps 352a-g and 354a-b, exposing the electrolyte layer 340.

After laser patterning/ablation, debris removal or cleaning (if needed) may comprise dry etching (e.g., using an etch chemistry and conditions that are at least somewhat selective for removal of the ACC material relative to the electrolyte material), a line beam laser (e.g., having a relatively small or narrow beam width), a high-velocity gas jet (e.g., a stream of dry CO₂, nitrogen or air), or by wet chemical cleaning (e.g., using distilled, deionized water, followed by an organic solvent such as acetone or isopropyl alcohol), optionally in the presence of applied ultrasound.

Advantages of laser patterning and/or ablation of the anode current collector layer 350 include the following:

Patterning is dry, so there is no effect on the battery layers or their chemistry

The patterned edges of the ACCs 350aa-ch are relatively sharp

Patterning throughput is typically higher than photolithography due to the relatively high laser scan rate

Lower cost, due to the elimination of lithography or shadow masks

Patterning flexibility is maximized, as laser ablation flows and/or is driven by a graphical drawing, which is easy and fast to change relative to photolithography and shadow masking

The patterned insulator layer between the cathode and the solid-state electrolyte under the areas of the ACC layer to be patterned reduces or effectively prevents thermal damage to the electrolyte and the cathode/electrolyte interface

Elimination of an etching process to pattern the ACC layer prevents Li⁺ transport to the electrolyte surface during patterning, which further prevents dead lithium formation and capacity loss

Referring again to FIG. 9B, the anode current collectors 350aa-ch at this stage may have area dimensions (i.e., length and width dimensions) that are 75-98% of the corresponding length and width dimensions, respectively, of the cells. The pull-back distance of the ACCs 350aa-ch from the cell edges should be sufficient to electrically isolate the ACCs from the CCC/substrate 300.

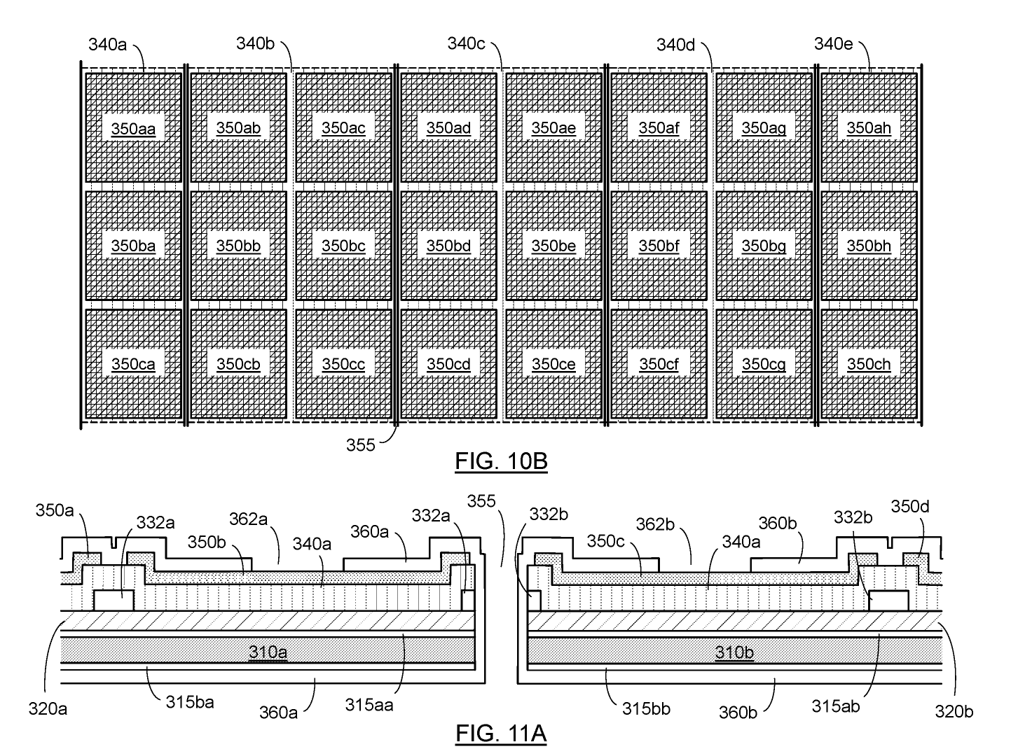

Referring to FIGS. 10A-B, the substrate 100 may be attached to a substrate support or holder (not shown), and the solid-state electrolyte layer 340, the cathode layer 320 and the substrate 300 (i.e., the metal foil sheet or roll 310 and barriers 315a-b) are cut or diced along the “ACC edges” of the battery cells to form an opening 355 every other cell, or every other row or column of cells (when the cells are in an array or on a multi-column roll; see, e.g., FIG. 10B). As shown in FIG. 10B, the cuts may be made in the lanes between the first and second rows or columns, the next-to-last and last rows or columns, and every other lane therebetween, and such that the substrate is divided or separated into strips of cell pairs (e.g., 350ab-ac, 350bb-bc, and 350cb-cc) and two single rows or columns of cells (e.g., the outermost rows or columns). This step is also optional in the present method. When the substrate support is a tape or sheet, it is generally a UV release tape or sheet, containing an adhesive on one or both major surfaces that loses its adhesive properties upon sufficient irradiation with ultraviolet (UV) light. The tape or sheet may be on a ring or other frame, configured to mechanically support the tape or sheet and allow some tension therein and some light to pass through the underside of the tape or sheet. When the substrate support is a substrate holder (e.g., for cutting or dicing by stamping), it may comprise a magnetic plate or chuck.

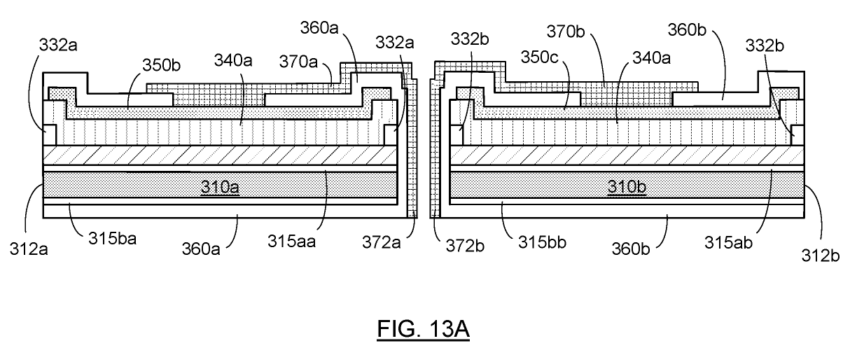

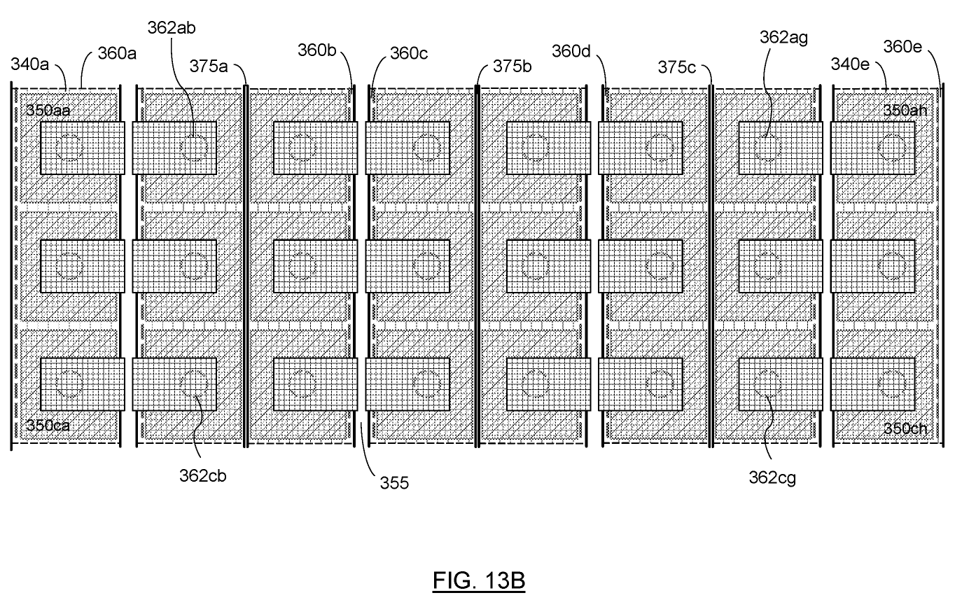

The openings 355 may be cut by laser (e.g., laser ablation), mechanical dicing, or stamping, for example. When the cells are in an array or on a multi-column roll or sheet, they may also be cut or diced along the x-direction in FIG. 10B between adjacent cells (e.g., every row, between cells 350aa-ah and cells 350ba-bh, and between cells 350ba-bh and cells 350ca-ch) to form isolated cell pairs. The sidewalls along the openings 355 fully expose the entire cell stack, including the CCC/substrate 300. In a further option, the entire cell stack may be cut or diced between every column of cells, resulting in “CCC edges” (see, e.g., FIG. 13A). FIG. 10B shows a layout view of initially-separated single-cell (e.g., outermost) strips and cell pair strips from the partial sheet or roll in FIG. 9B.

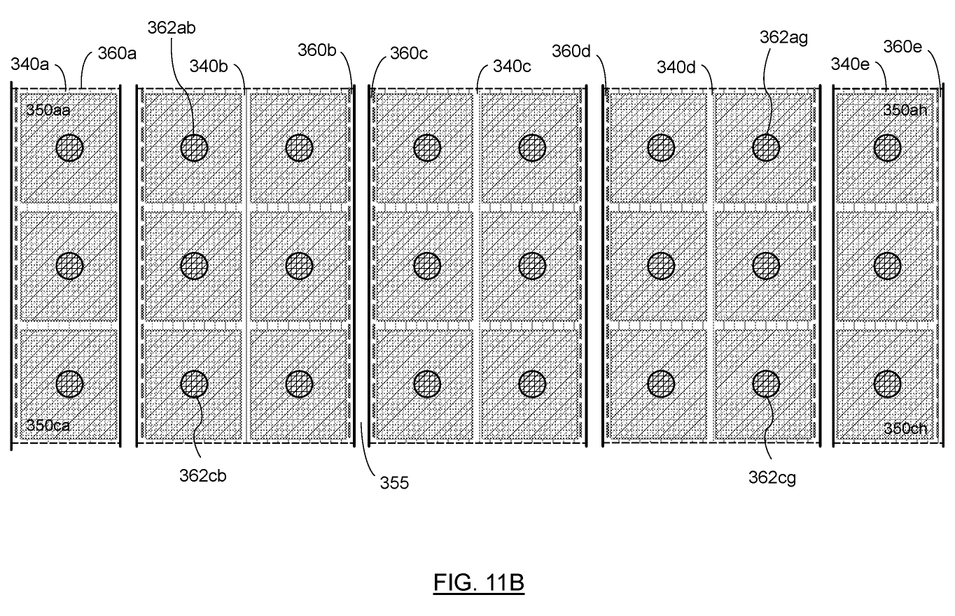

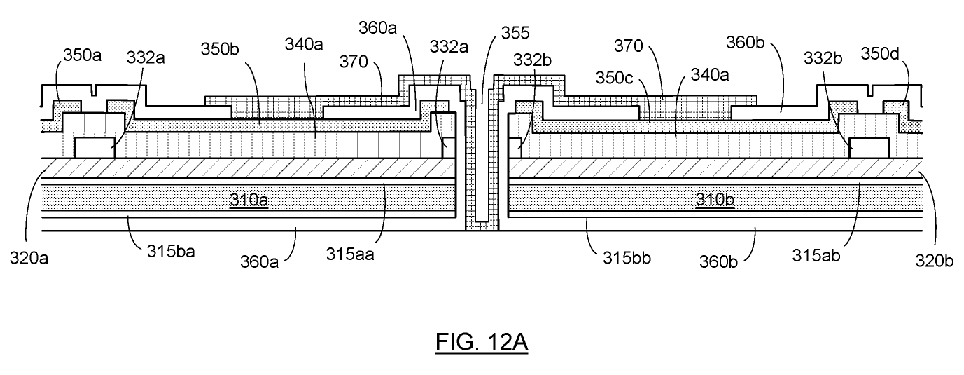

Referring now to FIG. 11A, the diced cell pairs (or strips of cell pairs) are substantially encapsulated with a mechanically compliant moisture barrier and electrical insulation film 360a-b. The barrier/insulation film 360a-b may cover the front or uppermost surface of the cells, the exposed “ACC edge” or surface of the cells facing the opening 355, and optionally, the backside surface of the cells. The barrier/insulation film 360a-b is preferably printed (e.g., by inkjet printing or screen printing) onto the cells, cell pairs, or cell strips, but it may also be formed by coating (e.g., extrusion coating) or blanket deposition and patterning. Each barrier/insulation film 360a-b includes an opening 362a-b therein over each anode current collector layer 350a-d. The openings in the barrier/insulation films 360a-b over the anode current collector layers 350a and 350d are not shown.

The barrier/insulation film 360a-b may comprise parylene, polyethylene, polypropylene, or another polyolefin, with or without a thin inorganic oxide overlayer such as SiO₂ (e.g., which may be formed by heating a tetraalkyl silicate such as tetraethyl orthosilicate [TEOS]). When printed, the material(s) of the barrier/insulation film 360a-b may be dissolved or suspended in an appropriate solvent (e.g., one or more organic solvents, such as a C₆-C₁₀ alkane or cycloalkane, a C₁-C₆ halogenated alkane or cycloalkane including one or more halogen atoms and that is in the liquid phase at 25 °C and 1 atm pressure, a C₄-C₆ cyclic or acyclic ether, a C₄-C₁₀ cyclic or acyclic polyether, a C₁-C₁₀ cyclic or acyclic alkanol, a C₃-C₄ ketone, a C₆-C₁₀ arene substituted with 1-3 C₁-C₄ alkyl groups, ) prior to printing. In certain embodiments, after printing or deposition, the material for the barrier/insulation film 360a-b may be cured (e.g., by irradiation with ultraviolet light) to provide certain desirable properties (e.g., a certain minimum hardness, optical property, adhesion, etc.).

FIG. 11B is a layout view of the initially separated cell and cell pair strips of FIG. 10B, encapsulated with barrier/insulation films 360a-e. The barrier/insulation film 360a-e covers the entire cell or cell pair strip, including the anode current collector layers 350aa-ch and the solid-state electrolyte layers 340a-d, except for an area of the anode current collector layers 350aa-ch exposed through the openings 362aa-ch in the barrier/insulation films 360a-d. The outlines of the underlying anode current collector layers 350aa-ch and electrolyte layers 340a-d are shown as dashed lines to indicate that they are covered by the respective barrier/insulation films 360a-e.

One advantage of printing to form the barrier/insulation films 360a-b (FIG. 11A) or 360a-e (FIG. 11B) is that the openings 362a-b (FIG. 11A) or 362aa-ch (FIG. 11B) may be formed on each cell over the corresponding anode current collector layer 350 during printing, without any need for additional processing (such as laser ablation, photolithographic patterning, etc.) to form the openings. Another advantage of printing is that, if additional singulation / separation cuts resulting in “CCC edges” are made to the cells prior to encapsulation, such CCC edges can be selectively not covered with the barrier/insulation film 360 by simply not printing the barrier/insulation film 360 on those edges.

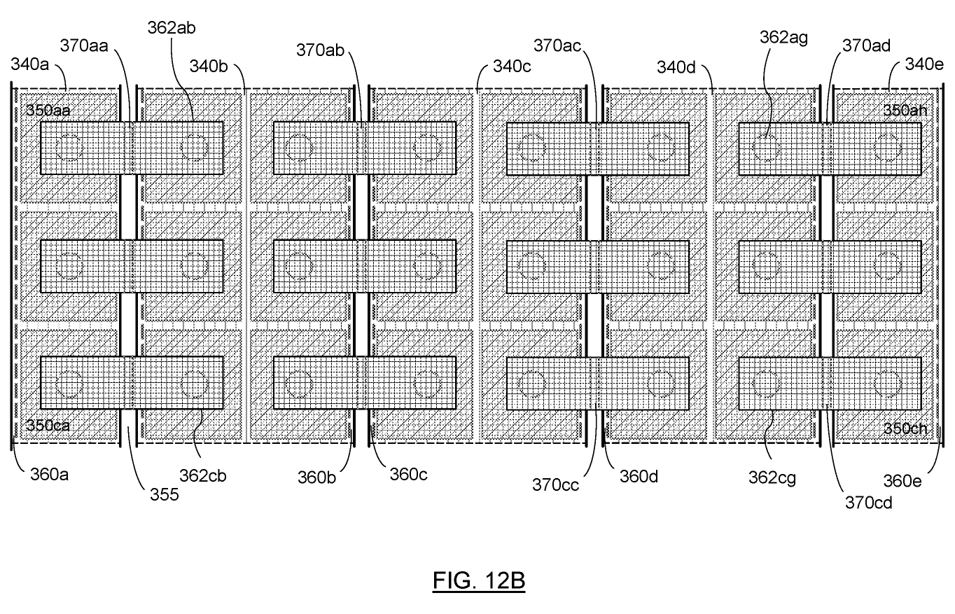

FIG. 12A shows the formation of a metal redistribution layer 370 along the ACC edges (in the opening 355) and in the openings 362a-d in the barrier/insulation films 360a-b to connect the anode current collector layers 350a-d to a subsequently formed external battery terminal. The redistribution layer 370 may comprise Cu, Ni, Al, or another suitable and/or stable (e.g., air- and/or water-stable, and/or lithium-compatible) metal, and may be formed by sputtering, ALD or thermal evaporation (e.g., through a mask that exposes a region of the cell corresponding to the pattern of the redistribution layers 370aa-cd [FIG. 12B], followed by removal of the mask), by blanket deposition, followed by photolithographic patterning and etching (as described herein), or by selective deposition, such as inkjet printing, aerosol-jet printing or screen printing. Printing may comprise the use of a conventional metal-containing ink or paste. In some embodiments, the length and width dimensions of the redistribution layer 370 (FIG. 12A) or layers 370aa-cd (FIG. 12B) may be on the scale of hundreds of microns (e.g., 200-1000 μm) or several millimeters (e.g., 1-10 mm), thereby enabling selective deposition processes such as inkjet printing, screen printing and shadow masking.

Low electrical resistance and a low curing temperature are desirable for the redistribution layers 370, and the redistribution layers 370 have a thickness typically in the range 0.25-2 µm on the uppermost surface of the cells. Due to liquid flow during printing, the entirety of the openings 362a-b / 362aa-ch may be filled with metal, which may be beneficial during battery cycling.

A single redistribution layer 370 is on the ACC edges 345a-d of adjacent cells (i.e., across the openings 355). Referring now to FIGS. 12A and 13A, the redistribution layers (or ACC redistribution traces) 370 conduct charge carriers between the anode current collector layers 350b-c (exposed through the vias or openings in the barrier/insulation layers 360a-b) to the ACC edges 372a-b, in the opposite direction from the CCC edges / contacts 312a-b (FIG. 13A).

Referring now to FIG. 12B, the ACC redistribution traces 370aa-cd electrically contact the ACCs 350aa-ch through the insulation layer openings 362aa-ch, but are physically and electrically insulated from the CCCs / substrates 310a-b (FIG. 12A) by the barrier/insulation films 360a-b. When the ACC redistribution traces 370aa-cd (FIG. 12B) are a metal, they form an intrinsic barrier to ambient ingress in the region of the vias or openings 362aa-ch. The ACC redistribution traces 370aa-cd are both physically on the top surface of the cell and cover at least part of the cell sidewalls. The ACC redistribution traces on the sidewalls (e.g., 372a-b in FIG. 13A) enable electrical connection of the cells to a terminal on a side or exterior surface of the packaged battery at a later stage of the method.

In one embodiment, the method comprises printing both the insulator for the barrier/insulation film 360a-b and the metal for the redistribution layers 370aa-cd, using dual (separate) inkjet printer heads. Preferably, the materials for the barrier/insulation film 360a-b and the ACC redistribution traces 370aa-cd are printed separately, with an optional curing step between the separate printing steps, if necessary or desired, although they may be printed simultaneously in some cases (e.g., where the solvents for the different layers are immiscible). This allows for faster cycle times and more efficient use of capital for manufacturing equipment.

In further embodiments involving printing the barrier/insulation film 360a-b and the redistribution layer 370aa-cd, prior to printing either or both layers, the method may further comprise testing the cells to determine battery functionality (e.g., charging, charge holding, and/or discharging properties). Cells that fail testing (i.e., that are identified as non-functional or insufficiently functional) may have the barrier/insulation film 360 and/or the redistribution layer 370 printed differently. For example, if the cells are tested prior to printing the barrier/insulation film 360, the via / opening in the barrier/insulation film 360 can be omitted in those cells that fail testing. In other words, when a cell fails testing (i.e., is identified as defective) prior to printing the barrier/insulation film 360, the barrier/insulation film 360 may completely cover the anode current collector layer 350 in the defective cell. Similarly, when a cell fails testing prior to printing the redistribution layer 370, the redistribution layer 370 may be omitted (i.e., not printed) in those defective cells.

FIGS. 13A-B show singulated cell strips, exposing CCC contact surfaces 312a-b of the metal foil sheets or rolls 310a and 310b (FIG. 13A). Prior to singulation (dicing), the cell pairs may be placed on a substrate holder (e.g., a magnetic plate or chuck) or an epoxy-coated tape (not shown). In this case, dicing along the CCC edges (to form openings 375a-c, FIG. 13B) creates the single cell strips and exposes the CCC contact surfaces 312a-b. Alternatively, dicing along the CCC edges can be performed at the same time as dicing along the ACC edges (FIGS. 10A-B), in which case the barrier/insulation film 360a-b and the redistribution layer 370 should be printed (to avoid depositing the film 360a-b and the layer 370 on the CCC edges). The epoxy coating on the tape may be used to keep the individual (i.e., further singulated) cells together during stacking, and may provide a passivation/sealing layer on one side or surface of the stacked cells during packaging. Thus, the coated tape may comprise a die attach film (DAF). Alternatively, an adhesive (e.g., an epoxy adhesive) may be coated or printed onto the upper or lower surface of the battery cells prior to stacking.

Singulation, both of the single-cell strips shown in FIGS. 13A-B and of the individual cells from the single-cell strips may be conducted by laser dicing, mechanical dicing, or stamping. When present, the epoxy coating and the tape may also be cut during singulation. The redistribution layer 370 (FIG. 12A) may be cut or separated to form redistribution layers 370a and 370b (FIG. 13A) either during singulation or during removal (e.g., from a chuck or other deposition / patterning apparatus) at or near the end of the redistribution layer formation process.

Both the single-cell strips and the individual singulated cells may be stacked to form a multi-cell stack, with the CCC (substrate) edges 312a-b along one side of the stack, and the ACC edges 372a-b along the opposite side. An adhesive layer (not shown) between cells in the stack can be from the coated tape or from a liquid die attach (DA) or printing process, and can be applied to the back and/or front major surface of the cells (e.g., every other cell), prior to or after cell or cell strip singulation. If not applied as part of a DA process, the adhesive can be applied by methods such as b-stage laminated film formation, dispensing, jetting, inkjet printing, screen printing, etc. The parallel cells in a multi-cell stack each additively contribute to the overall battery capacity. A dummy cell (e.g., an encapsulated metal foil substrate similar or identical to the metal foil, sheet, or film 310 or the barrier-covered metal foil, sheet, or roll 310/315) may be placed on top of the stack (e.g., of individually singulated cells) as a moisture and air barrier and to protect the stack from externally-caused damage. Optionally, markings on one major surface of the dummy cell can be used as external product markings.

Battery terminal dipping and plating on the stacked set of cells forms external electrical contacts. End terminals at the CCC and ACC edges (e.g., the exposed CCC surfaces 312 and the sidewall sections 372 of the redistribution layers 370, respectively) are dipped into or coated with a conductive epoxy to electrically gang the terminals and form the CCC and ACC terminals of the packaged battery. The conductive epoxy may comprise an Ag-filled or Ni-filled conductive epoxy paste. Alternatively, a pin-to-pin paste transfer method may be used, or a stable and/or noble metal such as Au, Pt, Pd or Cu can be used in place of the Ag or Ni. Plating a metal onto part or all of the CCC and ACC terminals creates a solderable surface for PCB attachment by the end user. For solderable termination, the epoxy surface may be plated with Ni, Ag, In, Sn, or a combination thereof (e.g., Ni, then with In or Sn). The conductive epoxy may contain a relatively high metal content, which can retard ambient ingress of oxygen or water vapor. Plating the epoxy with one or more pure metal layers may further block such ambient ingress. Both of these features help with ambient air resistance, particularly on the CCC edge, due to the barrier/insulation film 360 being diced at this edge during cell singulation from the single cell strips (FIGS. 13A-B).

### CONCLUSION

The foregoing descriptions of specific embodiments of the present disclosure have been presented for purposes of illustration and description. They are not intended to be exhaustive or to limit the disclosure to the precise forms disclosed, and obviously, many modifications and variations are possible in light of the above teaching. The embodiments were chosen and described in order to best explain the principles of the disclosure and its practical application, to thereby enable others skilled in the art to best utilize the disclosure and various embodiments with various modifications as are suited to the particular use contemplated.

1. A method of making solid-state battery cells, comprising:
forming a patterned insulator on a cathode layer on a substrate, the patterned insulator defining a border or boundary between adjacent ones of the solid-state battery cells,
blanket-depositing a solid-state electrolyte layer on the cathode layer and the patterned insulator,
blanket-depositing an anode current collector (ACC) layer on the solid-state electrolyte layer,
laser-patterning the ACC layer over the patterned insulator to form a plurality of anode current collectors (ACCs), wherein each ACC is in a corresponding one of the solid-state battery cells.

2. The method of claim 1, wherein the solid-state electrolyte layer completely covers the patterned insulator and contacts an exposed uppermost surface of the cathode layer.

3. The method of claim 1, wherein the patterned insulator has a thickness less than a thickness of a region of the solid-state electrolyte in direct contact with the cathode layer.

4. The method of claim 1, wherein the patterned insulator is formed by printing, followed by (i) drying and (ii) curing or annealing.

5. The method of claim 1, wherein the patterned insulator comprises an inorganic insulator selected from silicon and/or aluminum oxides and/or nitrides or an insulating organic polymer.

6. The method of claim 1, wherein the patterned insulator has a width of 5-1000 μm.

7. The method of claim 6, wherein laser-patterning the ACC layer forms gaps having a width of 2-500 μm between adjacent ones of the ACCs.

8. The method of claim 1, wherein the ACC layer is laser-patterned using a programmable laser patterning device, the method further comprises programming the programmable laser patterning device to form polylines in the ACC layer, and the polylines comprise a first plurality of parallel lines along a first direction and a second plurality of parallel lines along a second direction orthogonal to the first direction.

9. The method of claim 8, wherein the ACC layer is laser-patterned using light having a wavelength of 240-1400 nm, a pulse length of 5 femtoseconds to 1000 ns, a pulse frequency of 10⁵-10¹⁴ Hz, and a power of 10-1000 W.

10. The method of claim 1, wherein the cathode layer comprises a lithium metal oxide or lithium metal phosphate, and the ACC layer comprises graphite or a conductive metal incapable of forming an alloy with lithium, has a thickness of 0.1-5 µm, and is blanket-deposited on the solid-state electrolyte by spray coating, sputtering, evaporation, CVD, or ALD.

11. The method of claim 1, wherein blanket-depositing the solid-state electrolyte comprises (i) depositing a lithium phosphorus oxynitride (LiPON), a carbon-doped LiPON, or a tungsten oxide layer of a formula WO₃₊ₓ (0 ≤ x ≤ 1) by sputtering or atomic layer deposition (ALD), or (i) depositing one or more layers of a lithium lanthanum zirconium oxide (LLZO) in which some of the zirconium may be substituted with one or more of niobium, tantalum, aluminum, gallium, indium, vanadium, antimony or hafnium by a sol-gel technique.

12. The method of claim 1, further comprising cutting or dicing the cells through the patterned insulator, the cathode layer and the substrate to expose an ACC edge or sidewall of the solid-state battery cells, encapsulating the solid-state battery cells with an encapsulant including along the ACC edge or sidewall, forming a via or opening in the encapsulant in each of the solid-state battery cells to expose the ACC, and forming a redistribution layer in or over the via or opening and on the encapsulant along the ACC edge or sidewall.

13. The method of claim 12, wherein the redistribution layer comprises an elemental metal or an alloy consisting essentially of elemental metals, has a thickness of 0.25-2.0 μm, and is formed by (i) sputtering, atomic layer deposition (ALD), or thermal evaporation, followed by photolithographic patterning and etching, or (ii) selective deposition.

14. The method of claim 12, further comprising singulating the solid-state battery cells by cutting or dicing through the encapsulant, the patterned insulator, the cathode layer and the substrate to form a cathode current collector (CCC) contact in each of the solid-state battery cells, stacking the singulated battery cells so that the ACC edges or sidewalls are on a first side of the stacked battery cells and the CCC contacts are on an opposite side of the stacked battery cells, and packaging the singulated battery cells to form a solid-state battery.

15. The method of claim 1, wherein the substrate comprises a metal foil that functions as a cathode current collector in each of the solid-state battery cells.

16. The method of claim 15, wherein the metal foil comprises elemental aluminum, copper, titanium, nickel, iron, or an alloy thereof, and has a thickness of 10-100 μm.

17. A solid-state battery cell, comprising:
a substrate,
a cathode,
a patterned insulator on the cathode, along a border or boundary of the solid-state battery cell,
a solid-state electrolyte on the cathode and the patterned insulator, wherein the electrolyte, the patterned insulator, and the cathode are co-extensive,
an anode current collector (ACC) on the solid-state electrolyte,
an encapsulant on the ACC and at least an ACC sidewall of the electrolyte, the patterned insulator, and the cathode, and
a redistribution layer on the encapsulant and along the ACC sidewall, in electrical contact with the ACC.

18. The solid-state battery cell of claim 17, wherein the patterned insulator is along an entire border or boundary of the solid-state battery cell, the solid-state electrolyte completely covers the patterned insulator and contacts an exposed uppermost surface of the cathode, and the patterned insulator has a thickness less than a thickness of a region of the solid-state electrolyte in direct contact with the cathode.

19. The solid-state battery cell of claim 18, wherein the substrate comprises a metal foil that functions as a cathode current collector, the metal foil has a CCC contact, and the patterned insulator, the solid-state electrolyte layer, and the encapsulant are along an outermost periphery of the solid-state battery cell above the CCC contact.

20. The solid-state battery cell of claim 17, wherein:
the cathode comprises a lithium metal oxide or lithium metal phosphate,
the solid-state electrolyte comprises lithium phosphorus oxynitride (LiPON), carbon-doped LiPON, Li₂WO₄ or one or more layers of a lithium lanthanum zirconium oxide (LLZO), in which some of Zr may be substituted with one or more of niobium, tantalum, aluminum, gallium, indium, vanadium, antimony or hafnium, and
the patterned insulator comprises (i) an inorganic insulator selected from silicon and/or aluminum oxides and/or nitrides, or (ii) an insulating organic polymer.
